(19) United States
(12) Patent Application Publication
(10) Pub. No.: US 2014/0319388 A1
(43) Pub. Date: Oct. 30, 2014

(54) LASER APPARATUS AND EXTREME ULTRAVIOLET LIGHT GENERATION APPARATUS

(71) Applicant: GIGAPHOTON INC., Oyama (JP)

(72) Inventors: Masato MORIYA, Oyama (JP); Osamu WAKABAYASHI, Oyama (JP)

(73) Assignee: GIGAPHOTON INC., Oyama (JP)

(21) Appl. No.: 14/215,492

(22) Filed: Mar. 17, 2014

(30) Foreign Application Priority Data
Mar. 22, 2013 (JP) 2013-060369

(51) Int. Cl. H05G 2/00; H01S 3/10

(52) U.S. Cl. CPC H05G 2/008; H01S 3/10023
USPC 250/504 R; 359/349

(57) ABSTRACT

A laser apparatus may include a master oscillator configured to output a pulse laser beam, an amplifier disposed in a light path of the pulse laser beam, a wavelength selection element disposed in the light path of the pulse laser beam and configured to transmit light of a selection wavelength at higher transmittance than transmittance of light of other wavelengths, and a controller configured to change the selection wavelength of the wavelength selection element.

### CROSS-REFERENCE TO A RELATED APPLICATION

The present application claims priority from Japanese Patent Application No. 2013-060369 filed Mar. 21, 2013.

### BACKGROUND

1. Technical Field

The present disclosure relates to laser apparatuses and extreme ultraviolet light generation apparatuses.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A laser apparatus according to an aspect of the present disclosure may include a master oscillator, an amplifier, a wavelength selection element, and a controller. The master oscillator may be configured to output a pulse laser beam. The amplifier may be disposed in alight path of the pulse laser beam. The wavelength selection element may be disposed in the light path of the laser beam and configured to transmit light of a selection wavelength at higher transmittance than the transmittance of light of other wavelengths. The controller may be configured to change a selection wavelength of the wavelength selection element.

An extreme ultraviolet light generation apparatus according to another aspect of the present disclosure may include a laser apparatus, a chamber, a target supply device, and a laser beam focusing optical system. The laser apparatus may include a master oscillator configured to output a pulse laser beam, an amplifier disposed in a light path of the pulse laser beam, a wavelength selection element disposed in the light path of the laser beam and configured to transmit light of a selection wavelength at higher transmittance than the transmittance of light of other wavelengths, and a controller configured to change the selection wavelength of the wavelength selection element. The chamber may be provided with an incidence opening through which a pulse laser beam outputted from the laser apparatus passes into the inside thereof. The target supply device may be configured to output a target into the chamber. The laser beam focusing optical system may be configured to focus the pulse laser beam inside the chamber.

### BRIEF DESCRIPTION OF THE DRAWINGS

Hereinafter, selected embodiments of the present disclosure will be described with reference to the accompanying drawings.

FIG. 1 schematically illustrates a configuration of an exemplary LPP type EUV light generation system.

FIG. 2 schematically illustrates an exemplary configuration of an EUV light generation system according to an embodiment of the present disclosure.

FIGS. 3A and 3B illustrate a configuration of an etalon shown in FIG. 2.

FIG. 4 is a graph illustrating a relationship between wavelengths of light and amplification factors of an amplifier as well as a relationship between the wavelengths of light and transmittance of an etalon.

FIG. 5 illustrates an exemplary configuration of a laser apparatus shown in FIG. 2.

FIG. 6 is a timing chart of the laser apparatus shown in FIG. 5.

FIGS. 7A through 7C illustrate a configuration of a first variation on a wavelength selection element.

FIG. 8 is a flowchart illustrating an exemplary operation of a laser control unit connected to an etalon shown in FIG. 7C.

FIG. 9 is a flowchart illustrating selection wavelength control shown in FIG. 8.

FIG. 10 is a flowchart illustrating other selection wavelength control shown in FIG. 8.

FIG. 11 is a flowchart illustrating an initial setting process shown in FIG. 8.

FIGS. 12A and 12B illustrate a configuration of a second variation on the wavelength selection element.

FIGS. 13A and 13B illustrate a configuration of a third variation on the wavelength selection element.

FIG. 14 schematically illustrates a configuration of a fourth variation on the wavelength selection element.

FIG. 15 illustrates a configuration of a laser apparatus including a variation on the laser control unit.

FIG. 16 is a timing chart of the laser apparatus shown in FIG. 15.

FIG. 17 is a block diagram illustrating a general configuration of a controller.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein.

### Contents

1. Overview
2. Overview of EUV Light Generation System
2.1 Configuration
2.2 Operation
3. EUV Light Generation System Including Laser Apparatus
3.1 Configuration
3.2 Operation
3.3 Details of Etalon
3.4 Operation Timing Control
4. Variation on Wavelength Selection Element
4.1 Feedback-Controlled Etalon
4.1.1 Configuration
4.1.2 Operation
4.2 Etalon with Wide Control Range
4.3 Etalon Capable of Being Cooled
4.4 Combination of Grating and Slit
5. Variation on Laser Control Unit
6. Other Variations
7. Configuration of Controller

### 1. Overview

In an LPP type EUV light generation apparatus, a pulse laser beam outputted from a laser apparatus may be focused so that a target material outputted into a chamber is irradiated with the focused laser beam, whereby the target material may be turned into plasma. Rays of light including EUV light may be emitted from the plasma. The emitted EUV light may be collected by an EUV collector mirror disposed within the chamber and outputted to an external apparatus such as an exposure apparatus or the like.

The laser apparatus used in the LPP type EUV light generation apparatus may output a pulse laser beam with high pulse energy at a high repetition rate. In order to output such laser beam, the laser apparatus may include a master oscillator configured to output a pulse laser beam at a high repetition rate and at least one amplifier configured to amplify the pulse laser beam outputted from the master oscillator.

Not only the pulse laser beam outputted from the master oscillator but also reflection light of the pulse laser beam that has been reflected by the target material can enter the amplifier. In addition, the amplifier itself can output amplified spontaneous emission light (ASE). If the above reflection light or spontaneous emission light is amplified by the amplifier, the amplified light can enter and damage devices such as the master oscillator and the like. Further, in the case where the spontaneous emission light is amplified by the amplifier and strikes the target material, EUV light can be outputted in an unstable manner.

According to an aspect of the present disclosure, it is preferable that a wavelength selection element be disposed in a light path of a laser beam outputted from the mater oscillator, and the wavelength selection element be configured to change a selection wavelength of the wavelength selection element. Here, the “selection wavelength” refers to a wavelength of the light that the wavelength selection element transmits at higher transmittance than the transmittance of light of other wavelengths aside from the selection wavelength. In the case where the pulse laser beam outputted from the master oscillator is transmitted to travel toward the target material, the selection wavelength of the wavelength selection element may be caused to match the wavelength of the laser beam. In other cases, the selection wavelength of the wavelength selection element may be shifted to other wavelengths. Through this, the wavelength selection element can restrict the passing of the reflection light caused by the target material and the spontaneous emission light generated by the amplifier. Accordingly, it is possible to suppress the above reflection light and spontaneous emission light from entering devices such as the master oscillator and the like, suppress the spontaneous emission light from striking the target material, and so on.

### 2. Overview of EUV Light Generation System

2.1 configuration

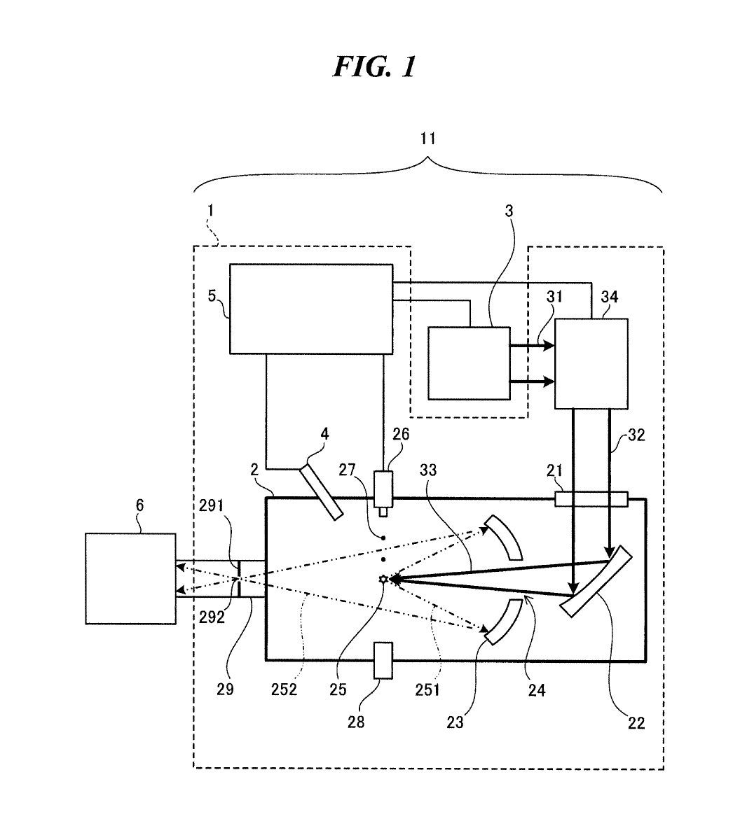

FIG. 1 schematically illustrates an exemplary configuration of an LPP type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may, for example, be provided in the chamber 2. The EUV collector mirror 23 may have a multi-layered reflective film formed on the spheroidal surface thereof. The reflective film may include a molybdenum layer and a silicon layer, which are alternately laminated. The EUV collector mirror 23 may have a first focus and a second focus, and may be positioned such that the first focus lies in a plasma generation region 25 and the second focus lies in an intermediate focus (IF) region 292 defined by the specifications of an external apparatus, such as an exposure apparatus 6. The EUV collector mirror 23 may have a through-hole 24 formed at the center thereof so that a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, trajectory, position, and speed of a target 27.

Further, the EUV light generation system 11 may include a connection part 29 for allowing the interior of the chamber 2 to be in communication with the interior of the exposure apparatus 6. A wall 291 having an aperture 293 may be provided in the connection part 29. The wall 291 may be positioned such that the second focus of the EUV collector mirror 23 lies in the aperture 293 formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation or posture of the optical element.

### 2.2 Operation

With continued reference to FIG. 1, a pulse laser beam 31 outputted from the laser apparatus 3 may pass through the laser beam direction control unit 34 and be outputted therefrom as the pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted and the direction into which the target 27 is outputted. Furthermore, the EUV light generation controller 5 may be configured to control at least one of: the timing when the laser apparatus 3 oscillates, the direction in which the pulse laser beam 33 travels, and the position at which the pulse laser beam 33 is focused. It will be appreciated that the various controls mentioned above are merely examples, and other controls may be added as necessary.

### 3. EUV Light Generation System Including Laser Apparatus

### 3.1 Configuration

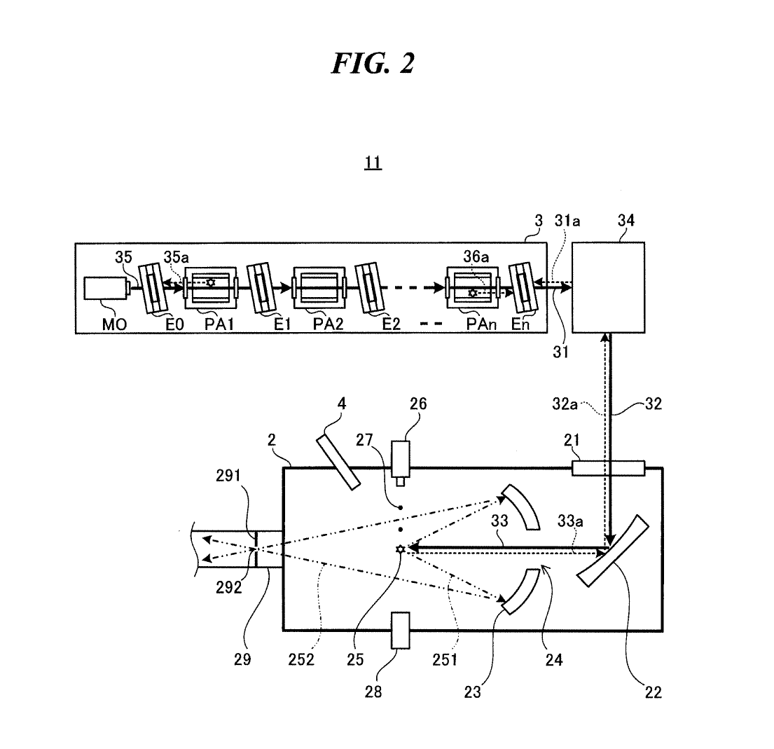

FIG. 2 schematically illustrates an exemplary configuration of the EUV light generation system 11 according to an embodiment of the present disclosure. The laser apparatus 3 may include a master oscillator MO, a plurality of amplifiers PA1, PA2, . . . , PAn, and a plurality of etalons E0, E1, E2, . . . , En. The master oscillator MO may output a pulse laser beam 35 including a first wavelength (to be explained later) at a predetermined repetition rate. The predetermined repetition rate may be 100 kHz, for example.

The plurality of amplifiers PA1, PA2, . . . , PAn may be arranged in this order in a light path of the pulse laser beam 35 outputted from the master oscillator MO. The number of the amplifiers may be “n”, where “n” may be an integer equal to or greater than 1. Each of the plurality of amplifiers PA1, PA2, . . . , PAn may be a CO₂ laser amplifier using CO₂ laser gas as a medium. Each of the plurality of amplifiers PA1, PA2, . . . , PAn may be configured to amplify light including the first wavelength at a larger amplification factor than the amplification factor of light including a second wavelength (to be explained later).

The amplifier PA1 may amplify the pulse laser beam 35 outputted from the master oscillator MO. The amplifier PA2 may amplify the pulse laser beam 35 amplified and outputted by the amplified PA1. The pulse laser beam 35 may be similarly amplified in sequence so that the pulse laser beam amplified and outputted by the amplifier PAn may enter the laser beam direction control unit 34 as the pulse laser beam 31.

The etalon E0 may be disposed in the light path of the pulse laser beam 35 between the master oscillator MO and the amplifier PA1. The etalon E1 may be disposed in the light path of the pulse laser beam 35 between the amplifier PA1 and the amplifier PA2. Likewise, the etalon E2 may be disposed in the light path of the pulse laser beam 35 outputted from the amplifier PA2, and the etalon En may be disposed in the light path of the laser beam 35 outputted from the amplifier PAn. The number of the etalons may be n+1 as shown in FIG. 2.

Each of the plurality of etalons E0, E1, E2, . . . , En can correspond to the wavelength selection element according to the present disclosure. Each of the plurality of etalons E0, E1, E2, . . . , En may be so configured as to be capable of changing the selection wavelength, which is a wavelength of light that is selectively transmitted by the etalon. Each of the plurality of etalons E0, E1, E2, . . . , En may be capable of being switched between a first state and a second state. The first state may be a state in which light including the first wavelength is transmitted at higher transmittance than light having the second wavelength. The second state may be a state in which light having the second wavelength is transmitted at higher transmittance than light having the first wavelength.

### 3.2 Operation

Each of the plurality of etalons E0, E1, E2, . . . , En may be changed to the first state at a timing when the pulse laser beam 35 outputted from the master oscillator MO passes therethrough. At other timings, each of the plurality of etalons E0, E1, E2, En may be changed to the second state.

Through this, the pulse laser beam 35 outputted from the master oscillator MO passes through the plurality of etalons E0, E1, E2, . . . , En, is amplified by the plurality of amplifiers PA1, PA2, . . . , PAn, and can be outputted from the laser apparatus 3 as the pulse laser beam 31. The pulse laser beam 31 may pass through, via the laser beam direction control unit 34, the window 21 to enter the chamber 2 as the pulse laser beam 32, reflect off the laser beam focusing mirror 22, and strike at least one target 27 as the pulse laser beam 33.

Meanwhile, the target 27 can reflect the pulse laser beam 33, by which the reflected beam becomes reflection light 33a. The reflection light 33a, also as reflection light 32a and reflection light 31a, can travel in the reverse direction of the light paths of the pulse laser beams 31, 32 and 33. However, in the case where the etalon En is in the above-mentioned second state at the timing when the reflection light 31a reaches the etalon En, the reflection light 31a can be attenuated in the etalon En.

Further, for example, in the case where the etalon E0 is in the second state at the timing when spontaneous emission light 35a generated in the amplifier PA1 reaches the etalon E0, the spontaneous emission light 35a can be attenuated in the etalon E0. Furthermore, for example, in the case where the etalon En is in the second state at the timing when spontaneous emission light 36a generated in the amplifier PAn reaches the etalon En, the spontaneous emission light 36a can be attenuated in the etalon En.

In the manner as described above, it is possible to suppress reflection light or spontaneous emission light from entering devices such as the master oscillator MO and the like, suppress the spontaneous emission light from striking the target 27, and so on.

### 3.3 Details of Etalon

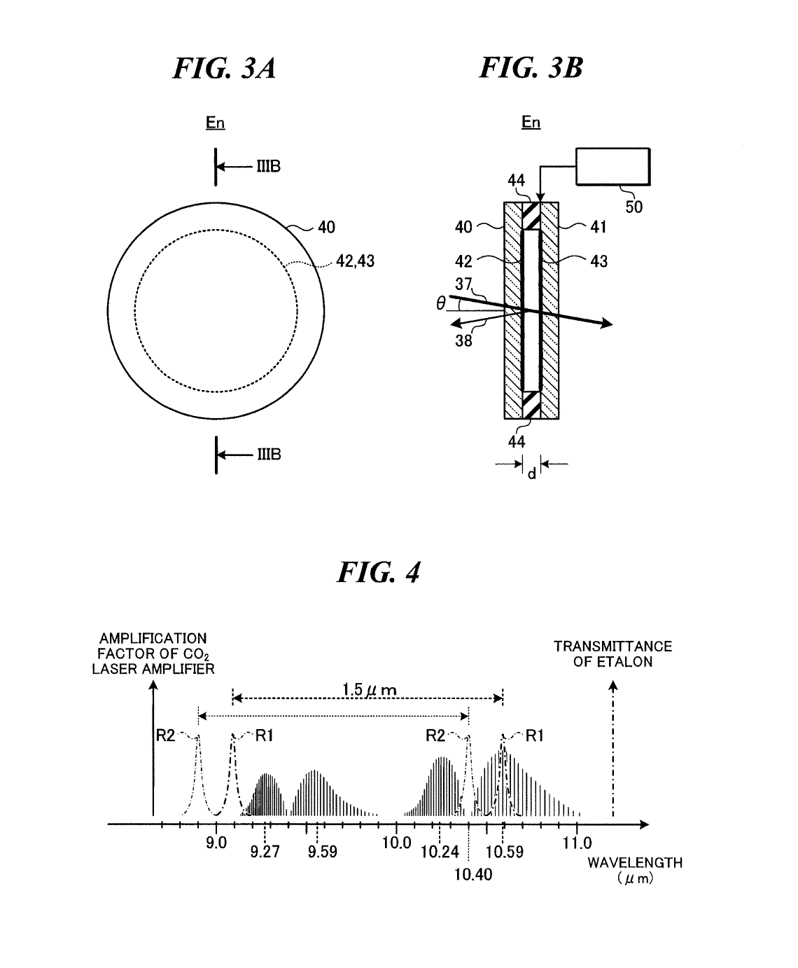

FIGS. 3A and 3B illustrate a configuration of the etalon shown in FIG. 2. More specifically, FIG. 3A is a plan view of the etalon En, and FIG. 3B is a cross-sectional view of the etalon En taken along a line IIIB-IIIB in FIG. 3A. Although the configuration of the etalon En is discussed hereinafter, the configurations of the etalons E0, E1, E2, and so on may be the same.

The etalon En may include a pair of diamond substrates 40 and 41, partially reflective films 42 and 43, a piezoelectric element 44, and a drive power supply 50. Note that in FIG. 3A, the drive power supply 50 is not illustrated.

The partially reflective film 42 may be coated upon one surface of the diamond substrate 40, while the partially reflective film 43 may be coated upon one surface of the diamond substrate 41. The pair of diamond substrates 40 and 41 may be disposed so that the partially reflective films 42 and 43 oppose each other. At a circumferential edge portion of the pair of diamond substrates 40 and 41, the piezoelectric element 44 may be fixed between the diamond substrates 40 and 41. The piezoelectric element 44 may include a piezoelectric ceramic shaped in a ring form and electrodes (not shown) disposed at both ends of the piezoelectric ceramic. The drive power supply 50 may be configured to be connected with the electrodes so that the piezoelectric element 44 deforms according to a voltage applied by the drive power supply 50.

As shown in FIG. 3B, in the case where light 37 enters the etalon En from the left side of the etalon En, that is, from the diamond substrate 40 side, a first portion of the light 37 can be reflected by the partially reflective film 42 toward the left side in the drawing, while part of the other portion thereof can pass through the partially reflective film 42.

Of the light 37 that has passed through the partially reflective film 42, a second portion thereof can pass through the partially reflective film 43 toward the right side in the drawing. Part of the other portion of the light 37 that has passed through the partially reflective film 42 can be reflected by the partially reflective film 43.

Of the light 37 that has been reflected by the partially reflective film 43, a third portion thereof can pass through the partially reflective film 42 toward the left side in the drawing. Part of the other portion of the light 37 that has been reflected by the partially reflective film 43 can be reflected by the partially reflective film 42, and a fourth portion of the light 37 reflected by the partially reflective film 42 can pass through the partially reflective film 43 toward the right side in the drawing.

In the case where the above second and fourth portions are superposed upon each other, beams of light of a wavelength corresponding to a distance “d” between the partially reflective films 42 and 43 coincide with each other in phase and can intensify each other, whereas beams of light of a wavelength which does not correspond to the distance “d” between the partially reflective films 42 and 43 do not coincide with each other in phase and can weaken each other. As a result of this interferential effect, beams of light of the wavelength corresponding to the distance “d” between the partially reflective films 42 and 43 can selectively pass through the etalon En. Accordingly, through controlling the voltage applied to the piezoelectric element 44 by the drive power supply 50, the distance “d” between the partially reflective films 42 and 43 is controlled. As a result, the selection wavelength of the etalon En can be controlled.

Likewise, the above first and third portions are also superposed upon each other so as to become reflection light 38. In order to suppress the reflection light 38 from returning to the master oscillator MO, it is preferable that the partially reflective films 42 and 43 of the etalon En be disposed being slanted with respect to an optical axis of the pulse laser beam 35 (see FIG. 2).

When the selection wavelength of the etalon En is taken as λ, a relation indicated by an equation below is generally known.

λ=2d/m cos θ

In the equation, “m” can be an integer equal to or greater than 1, and θ can be an incidence angle of light with respect to the partially reflective films 42 and 43. As can be understood from this equation, when the distance “d” between the partially reflective films 42 and 43 is determined, the selection wavelength λ of the etalon En can take a plurality of values according to the value of “m”.

FIG. 4 is a graph illustrating a relationship between wavelengths of light and amplification factors of the amplifier as well as a relationship between the wavelengths of light and transmittance of the etalon. As indicated by vertical solid lines in FIG. 4, there can be a plurality of wavelengths of light that the CO₂ laser amplifier as an example of the amplifiers PA1, PA2, . . . , PAn can amplify. In particular, the CO₂ laser amplifier can amplify light at a wavelength of 10.59 μm at a large amplification factor. Accordingly, for example, if the master oscillator MO is configured so that the pulse laser beam 35 outputted therefrom includes light at a wavelength of 10.59 μm, it is possible to effectively make use of amplification performance of the CO₂ laser amplifier. In this case, it is preferable that the first state of the etalon En be so set as to transmit light at a wavelength of 10.59 μm at high transmittance. In other words, the wavelength of 10.59 μm may be the first wavelength.

Further, as shown in FIG. 4, the CO₂ laser amplifier can have another peak of amplification at a wavelength of 10.24 μm. In the following description, the wavelength of 10.24 μm may be a third wavelength. Meanwhile, it can be stated that the CO₂ laser amplifier amplifies light at a wavelength of 10.40 μm at a low amplification factor or does not amplify it at all. Accordingly, for example, it is preferable that the second state of the etalon En be so set as to transmit light at a wavelength of 10.40 μm at high transmittance and transmit light at a wavelength of 10.59 μm at low transmittance. In other words, the wavelength of 10.40 μm may be the second wavelength.

As described above with reference to FIG. 3, there can be a plurality of values for the selection wavelength λ of the etalon En according to the value of “m”. As indicated by dot-dash lines R1 in FIG. 4, when the etalon En transmits the light at a wavelength of 10.59 μm, light at other wavelengths can be also transmitted at high transmittance by the etalon En. In a transmittance spectrum of the etalon, an interval between a plurality of peaks of transmittance is referred to as a free spectral range.

Meanwhile, as shown in FIG. 4, the CO₂ laser amplifier can also have peaks of amplification at a wavelength of 9.59 μm and a wavelength of 9.27 μm, respectively, in addition to a wavelength of 10.24 μm as the third wavelength. In the following description, the wavelength of 9.59 μm may be a fourth wavelength and the wavelength of 9.27 μm may be a fifth wavelength. It is preferable that the etalon En be configured so that the third through fifth wavelengths are included within a free spectral range. For example, in the case where the etalon En is in the first state, if the free spectral range of the etalon En is 1.5 μm, the etalon En can make the third through fifth wavelengths be included within the free spectral range, as indicated by the dot-dash lines R1 in FIG. 4. Accordingly, light of the third through fifth wavelengths can be attenuated by the etalon En. Further, in the case where the etalon En is in the second state, the etalon En can make the third through fifth wavelengths be included within the free spectral range as well, as indicated by dot-dash lines R2 in FIG. 4. With this, it is possible to suppress the spontaneous emission light from being amplified, entering devices such as the master oscillator MO and the like, striking the target 27, and so on.

The free spectral range of the etalon can be given by Equation 1 as follows.

FSR=λ²/2nd (Equation 1)

In Equation 1, “FSR” stands for a free spectral range, and FSR may be 1.5 μm, for example; “λ” is a selection wavelength, and λ may be 10.59 μm, for example; and “n” is an absolute index of refraction between partially reflective films, and n may be 1, for example.

Further, “d” may be a distance between the partially reflective films. From Equation 1, d=37.4 μm can be calculated.

A variation amount Δd of the distance “d”, needed to change the etalon En from the first state in which the first wavelength 10.59 μm is transmitted to the second state in which the second wavelength 10.40 μm is transmitted, is calculated as follows.

$$\begin{matrix}Δ d = Δ λ \times λ / FSR \\ = ( 10.59 - 10.40 ) \times 10.59 / 1.5 \\ = 1.34\end{matrix}$$

Accordingly, the drive power supply 50 may apply a voltage to the piezoelectric element 44 so that the distance “d” between the partially reflective films is changed by 1.34 μm due to the deformation of the piezoelectric element 44.

The wavelength of 10.40 μm is made to be the second wavelength in the above description. However, other wavelength at which the amplification factor of the CO₂ laser amplifier is small, for example, a wavelength in a range of 10.3 μm to 10.5 μm or 9.7 μm to 10.2 μm, may be made to be the second wavelength.

Further, the wavelength of 10.59 μm is made to be the first wavelength in the above description. However, other wavelength at which the amplification factor of the CO₂ laser amplifier is large, for example, a wavelength of 10.24 μm, 9.59 μm, or 9.27 μm, may be made to be the first wavelength. Furthermore, any one of the wavelengths 10.59 μm, 10.24 μm, 9.59 μm and 9.27 μm, except the one that is made to be the first wavelength, may be made to be the third wavelength.

### 3.4 Operation Timing Control

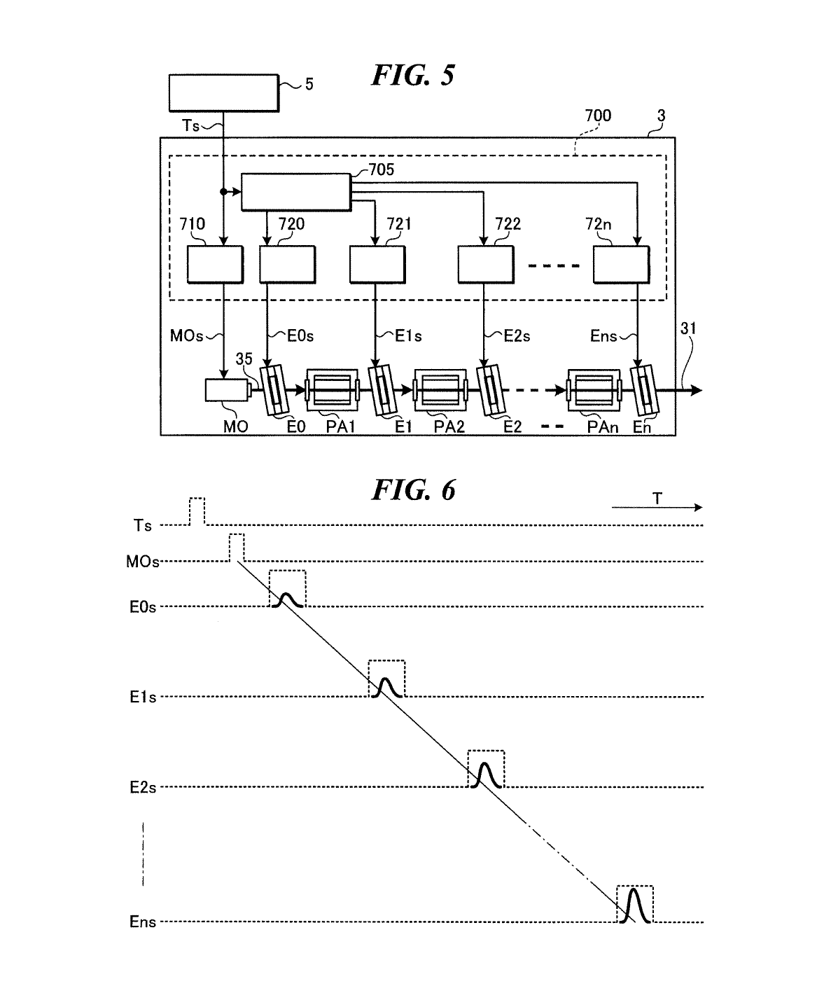

FIG. 5 illustrates an exemplary configuration of the laser apparatus 3 shown in FIG. 2. The laser apparatus 3 may include a laser control unit 700. The laser control unit 700 may include a delay circuit 705 and a plurality of one-shot circuits 710, 720, 721, 722, . . . , 72n.

The delay circuit 705 and the one-shot circuit 710 may be connected with the EUV light generation controller 5 via signal lines. The one-shot circuit 710 may be connected with the master oscillator MO via a signal line. The delay circuit 705 may be connected with the one-shot circuits 720, 721, 722, 72n via signal lines, respectively. The one-shot circuits 720, 721, 722, . . . , 72n may be connected with the respective drive power supplies 50 of the etalons E0, E1, E2, . . . , En via signal lines. Note that the drive power supply 50 illustrated in FIG. 3B is omitted in FIG. 5.

The EUV light generation controller 5 may output a trigger signal Ts to the delay circuit 705 and the one-shot circuit 710. The one-shot circuit 710 may output a drive signal MOs to the master oscillator MO based on the trigger signal Ts. The delay circuit 705 may output delay signals, respectively being delayed with respect to the reception timing of the trigger signal Ts, to the one-shot circuits 720, 721, 722, . . . , 72n. The one-shot circuits 720, 721, 722, . . . , 72n may be supplied with the respective delay signals at different timings. The one-shot circuits 720, 721, 722, . . . , 72n may output drive signals E0s, E1s, E2s, . . . , Ens to the respective drive power supplies 50 of the etalons E0, E1, E2, . . . , En (see FIG. 3B) based on the delay signals.

FIG. 6 is a timing chart of the laser apparatus shown in FIG. 5. In FIG. 6, the horizontal direction represents the passage of time T, while broken lines represent the trigger signal Ts and the drive signals MOs, E0s, E1s, E2s, . . . , Ens. First, the trigger signal Ts may be outputted from the EUV light generation controller 5. Immediately after the trigger signal Ts is outputted, the one-shot circuit 710 may output the drive signal MOs and the master oscillator MO may output the pulse laser beam 35 in response to the drive signal MOs.

At the timing immediately before the pulse laser beam 35 outputted from the master oscillator MO reaches the etalon E0, the one-shot circuit 720 may output the drive signal E0s to the etalon E0. During the drive signal E0s being ON, the etalon E0 may be in the first state in which light of the first wavelength is transmitted and the pulse laser beam 35 may pass through the etalon ED. Waveforms of the pulse laser beam 35 are illustrated with solid lines in FIG. 6. The output timing of the delay signal outputted by the delay circuit 705 may be reflected on a delay time of the drive signal E0s with respect to the drive signal MOs. This delay time may be determined based on a value obtained by a calculation in which a light path length between the master oscillator MO and the etalon E0 is divided by the speed of light.

At the timing immediately before the pulse laser beam 35 outputted from the amplifier PA1 reaches the etalon E1, the one-shot circuit 721 may output the drive signal E1s to the etalon E1. During the drive signal E1s being ON, the etalon E1 may be in the first state in which light of the first wavelength is transmitted and the pulse laser beam 35 may pass through the etalon E1. The delay time of the drive signal E1s with respect to the drive signal E0s may be determined based on a value obtained by a calculation in which a light path length between the etalon E0 and the etalon E1 is divided by the speed of light.

Likewise, at the timing immediately before the pulse laser beam 35 reaches the etalon E2, the one-shot circuit 722 may output the drive signal E2s to the etalon E2 and the pulse laser beam 35 may pass through the etalon E2. At the timing immediately before the pulse laser beam 35 reaches the etalon En, the one-shot circuit 72n may similarly output the drive signal Ens to the etalon En and the pulse laser beam 35 may pass through the etalon En. Through this, the pulse laser beam 35 may pass through the etalons E0 through En and may be outputted from the laser apparatus 3 as the pulse laser beam 31.

Length of time during which the respective drive signals E0s, E1s, E2s, . . . , Ens are ON may be approximately 30 ns to 5,000 ns depending on pulse width of the pulse laser beam 35. At the timing immediately after the pulse laser beam 35 has passed through the respective etalons E0 through En, the corresponding drive signals E0s, E1s, E2s, . . . , Ens may be OFF. During the drive signals E0s, E1s, E2s, . . . , Ens being OFF, the etalons E0 through En may be respectively in the second state in which light of the second wavelength is transmitted and reflection light from the targets and spontaneous emission light from the amplifiers may be attenuated.

According to the process shown in FIG. 6, the laser control unit 700 can switch the etalon En between the first state and the second state thereof in synchronization with respective pulses included in the pulse laser beam 35. Therefore, even during a burst operation in which multiple pulses are repeatedly outputted, it is possible to suppress reflection light and spontaneous emission light from entering devices such as the master oscillator MO and the like, suppress the spontaneous emission light from striking the target 27, and so on.

### 4. Variation on Wavelength Selection Element

### 4.1 Feedback-Controlled Etalon

### 4.1.1 Configuration

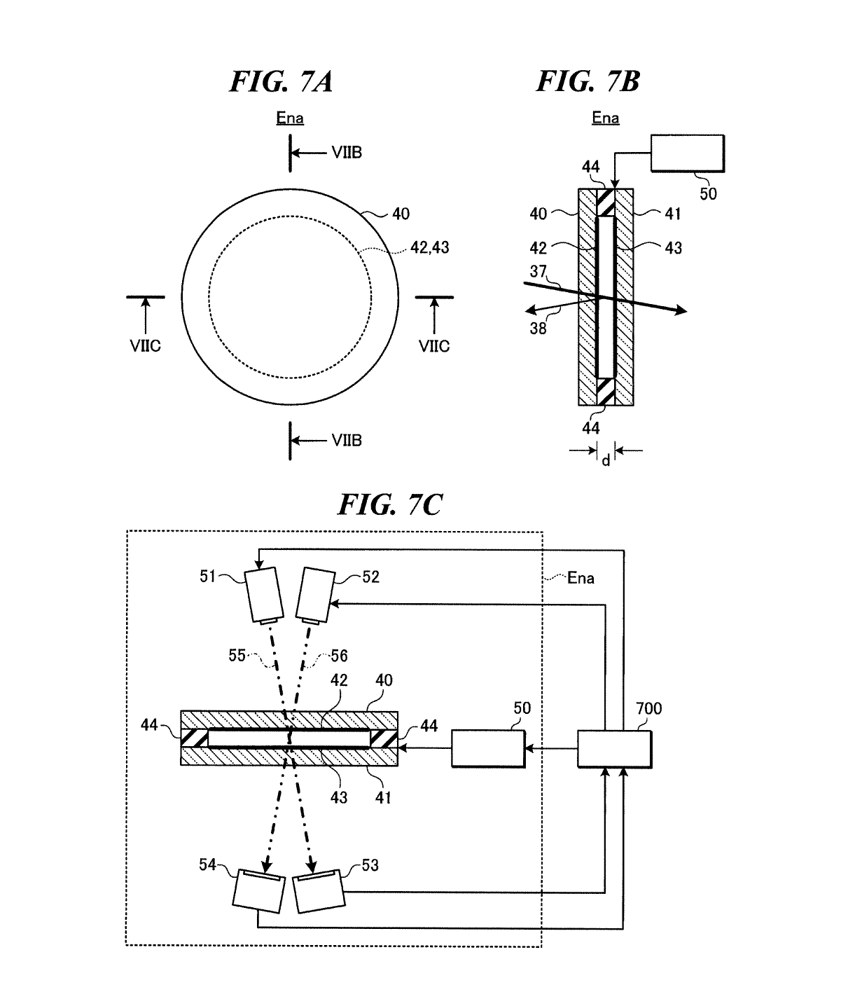

FIGS. 7A through 7C illustrate a configuration of a first variation on the wavelength selection element. More specifically, FIG. 7A is a plan view of an etalon Ena; FIG. 7B is a cross-sectional view of the etalon Ena taken along a line VIIB-VIIB in FIG. 7A; and FIG. 7C is a cross-sectional view of the etalon Ena taken along a line VIIC-VIIC in FIG. 7A. Note that in FIG. 7C, configurations related to the constituent elements of the etalon Ena are also illustrated as part of the etalon Ena. The configuration of the variation on the etalon En will be described hereinafter; however, the configurations of the etalons E0, E1, E2 and so on may be the same as the configuration of this variation.

The etalon Ena shown in FIGS. 7A through 7C may include a first light source 51, a second light source 52, a first light sensor 53, and a second light sensor 54, in addition to the configuration of the etalon En having been discussed with reference to FIGS. 3A and 3B. The first light source 51, the second light source 52, the first light sensor 53, and the second light sensor 54 may be connected with the laser control unit 700 via signal lines. The first light source 51 and the second light source 52 may be quantum cascade lasers. In FIGS. 7A and 7B, the first light source 51, the second light source 52, the first light sensor 53, the second light sensor 54, and the laser control unit 700 are not illustrated. The drive power supply 50 may be connected with the one-shot circuit 72n of the laser control unit 700 via a signal line and also connected with a voltage control circuit (not shown) of the laser control unit 700 via a signal line. Note that the one-shot circuit 72n illustrated in FIG. 5 is omitted in FIG. 7C.

The first light source 51 may output a laser beam 55 including the first wavelength toward the partially reflective films 42 and 43 under the control of the laser control unit 700. The second light source 52 may output a laser beam 56 including the second wavelength toward the partially reflective films 42 and 43 under the control of the laser control unit 700. The laser beam 55 outputted by the first light source 51 and the laser beam 56 outputted by the second light source 52 may not be pulse laser beams. An incidence angle of the laser beam 55 outputted by the first light source 51 and an incidence angle of the laser beam 56 outputted by the second light source 52 with respect to the respective partially reflective films 42 and 43 may substantially match an incidence angle of the pulse laser beam 35 outputted by the master oscillator MO with respect to the partially reflective films 42 and 43. However, incidence surfaces of the laser beams 55, 56 and an incidence surface of the pulse laser beam 35 with respect to the partially reflective films 42 and 43 may be shifted from each other.

The first light sensor 53 may be disposed in a light path of the laser beam 55 that is outputted from the first light source 51 and passes through the partially reflective films 42 and 43, and may detect light intensity of the laser beam 55. The second light sensor 54 may be disposed in a light path of the laser beam 56 that is outputted from the second light source 52 and passes through the partially reflective films 42 and 43, and may detect light intensity of the laser beam 56. The first light sensor 53 and the second light sensor 54 may respectively output data of the detected light intensity to the laser control unit 700.

The laser control unit 700 may generate a voltage control signal using the voltage control circuit (not shown) based on the light intensity data outputted by the first and second light sensors 53 and 54. The laser control unit 700 may send this voltage control signal to the drive power supply 50 aside from the drive signal Ens that is outputted by the one-shot circuit 72n and is either ON or OFF. More specifically, when the drive signal Ens outputted by the one-shot circuit 72n is ON, the voltage control signal that is generated based on the output from the first light sensor 53 may be sent to the drive power supply 50. When the drive signal Ens outputted by the one-shot circuit 72n is OFF, the voltage control signal that is generated based on the output from the second light sensor 54 may be sent to the drive power supply 50. The drive power supply 50 may apply a voltage to the piezoelectric element 44 in accordance with the voltage control signal that has been sent thereto. Through this, the selection wavelength of the etalon Ena may be adjusted.

Other points in this variation may be the same as those in the configuration of the etalon En having been discussed with reference to FIGS. 3A and 3B.

### 4.1.2 Operation

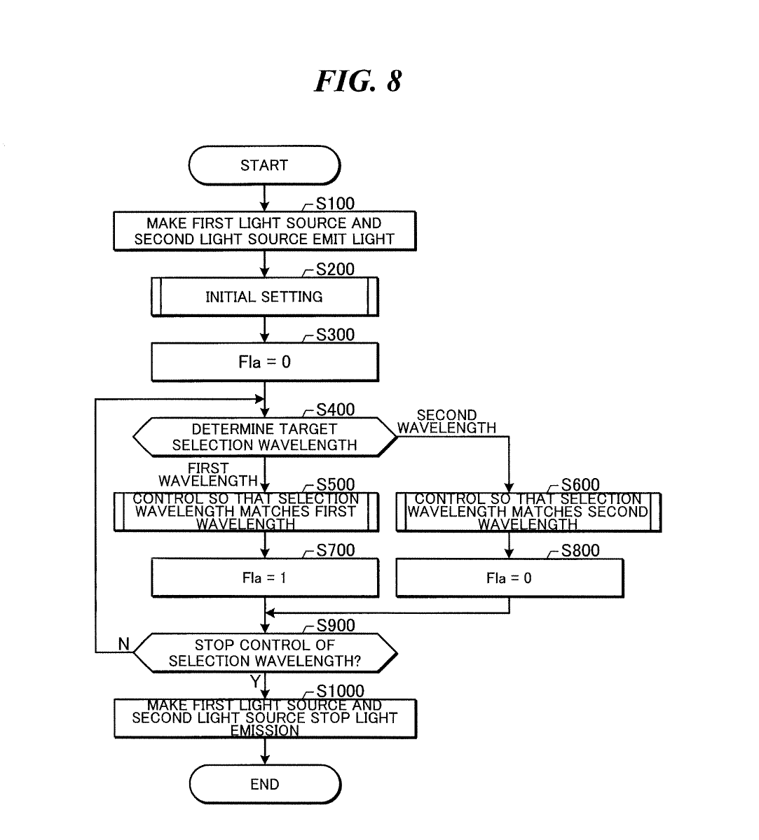

FIG. 8 is a flowchart illustrating an exemplary operation of the laser control unit 700 connected to the etalon shown in FIG. 7C. The laser control unit 700 may perform feedback control on the etalon Ena as follows, based on the output from the first and second light sensors 53 and 54.

First, the laser control unit 700 may make the first and second light sources 51 and 52 emit light (S100). Through this, the first light source 51 may emit a laser beam including the first wavelength and the second light source 52 may emit a laser beam including the second wavelength.

Next, the laser control unit 700 may perform initial setting (S200). Details of the process in S200 will be explained later. The laser control unit 700, after having performed S200, may set a first flag F1a to “0” (S300).

Subsequently, the laser control unit 700 may determine a target selection wavelength (S400). In the determination of the target selection wavelength, it may be determined which of the first and second wavelengths should be the target wavelength. For example, in the case where the drive signal Ens outputted by the one-shot circuit 72n is ON, the laser control unit 700 may determine the first wavelength to be the target selection wavelength. In the case where the drive signal Ens outputted by the one-shot circuit 72n is OFF, the laser control unit 700 may determine the second wavelength to be the target selection wavelength.

In the case where the first wavelength is determined to be the target selection wavelength, the laser control unit 700 may make the process go to S500. In the case where the second wavelength is determined to be the target selection wavelength, the laser control unit 700 may make the process go to S600.

In S500, the laser control unit 700 may control the etalon En so that the selection wavelength of the etalon En matches the first wavelength. Details of the process in S500 will be explained later. The laser control 700, after having performed S500, may set the value of the first flag F1a to “1” (S700). After S700, the laser control unit 700 may make the process go to S900.

In S600, the laser control unit 700 may control the etalon En so that the selection wavelength of the etalon En matches the second wavelength. Details of the process in S600 will be explained later. The laser control 700, after having performed S600, may set the value of the first flag F1a to “0” (S800). After S800, the laser control unit 700 may make the process go to S900.

In S900, the laser control unit 700 may determine whether or not to stop the selection wavelength control. Whether or not to stop the selection wavelength control may be determined, for example, based on whether or not the laser control unit 700 has received a signal specifying the stop of output of the pulse laser beam 31 from the EUV light generation controller 5. If the selection wavelength control is not to be stopped (S900: NO), the laser control unit 700 may return the process to S400 so as to repeat the processes of S400 through S900. If the selection wavelength control is to be stopped (S900: YES), the laser control unit 700 may make the process go to S1000.

In S1000, the laser control unit 700 may make the first and second light sources 51 and 52 stop the light emission, and may end a set of processes in this flowchart.

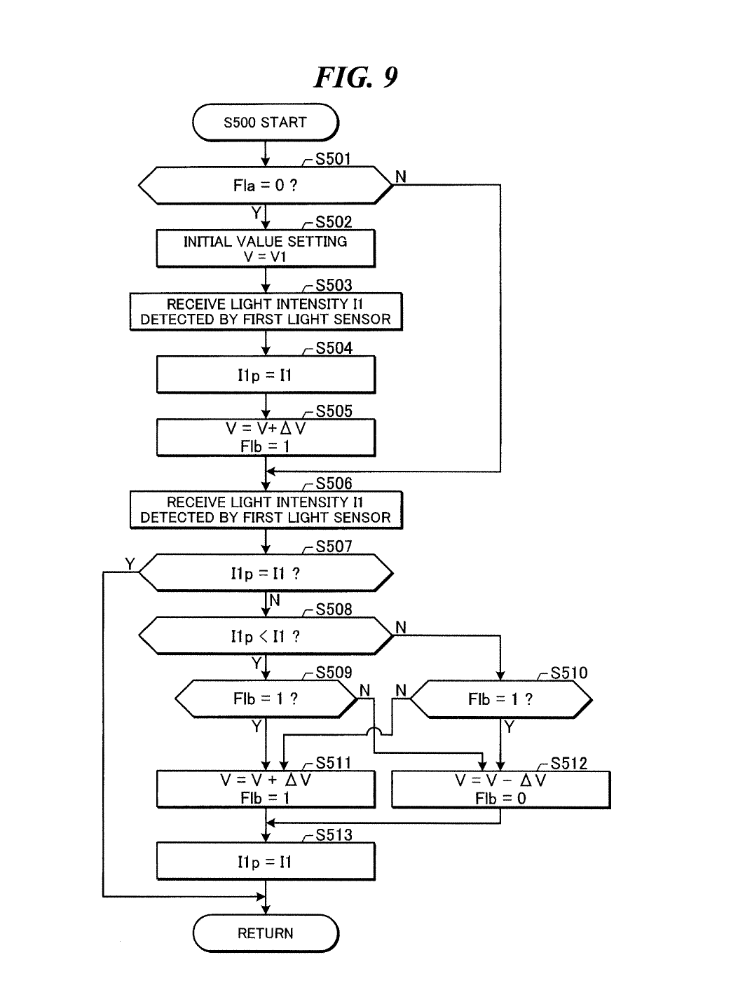

FIG. 9 is a flowchart illustrating the above-mentioned selection wavelength control shown in FIG. 8. A set of processes shown in FIG. 9 may be performed, by the laser control unit 700, as a subroutine of S500 shown in FIG. 8.

First, the laser control unit 700 may determine the value of the first flag F1a (S501). In the case where the processes of S400 through S900 shown in FIG. 8 have already been performed at least once, and the target selection wavelength was the second wavelength in the previous processes of S400 through S900, the value of the first flag F1a can be “0” (S501: YES) because the process of S800 was performed. In this case, because the target selection wavelength has been changed to the first wavelength in the current processes of S400 through S900, the laser control unit 700 may perform processes such as initial value setting (S502) and so on.

Meanwhile, in the case where the target selection wavelength was also the first wavelength in the previous processes of S400 through S900, the value of the first flag F1a can be “1” (S501: NO) because the process of S700 mentioned before was performed. In this case, because the target selection wavelength has not been changed yet, the laser control unit 700 may skip the processes such as the initial value setting (S502) and so on and make the process go to S506, which will be explained later in detail.

Note that, in the case where the laser control unit 700, after having performed S300 in FIG. 8, performs the processes of S400 through S900 for the first time, the laser control unit 700 may determine that the value of the first flag F1a is “0”.

If the value of the first flag F1a is “0” (S501: YES), the laser control unit 700 may set a voltage V to an initial value V1 (S502). The laser control unit 700 may send a voltage control signal to the drive power supply 50 so that the voltage V is applied to the piezoelectric element 44.

Next, the laser control unit 700 may receive data of light intensity I1 of a laser beam that has been detected by the first light sensor 53 (S503).

Subsequently, the laser control unit 700 may make a memory 1002 (to be explained later) store the light intensity I1 having been received in S503 as past light intensity I1p (S504).

Then, the laser control unit 700 may add a predetermined value ΔV to the voltage V and make a result of this addition be overwritten and stored in the memory 1002 as a new voltage V (S505). The laser control unit 700 may send a voltage control signal to the drive power supply 50 so that the above new voltage V is applied to the piezoelectric element 44. In addition, the laser control unit 700 may set the value of a second flag F1b to “1”, make the memory 1002 store this value of the flag, and make the process go to S506.

In S506, the laser control unit 700 may receive data of light intensity I1 of a laser beam that has been newly detected by the first light sensor 53.

Next, the laser control unit 700 may determine whether or not the newly detected light intensity I1 of the laser beam is equal to the past light intensity I1p currently stored in the memory 1002 (I1P=I1) (S507). If the newly detected light intensity I1 of the laser beam is equal to the past light intensity I1p (S507: YES), the laser control unit 700 may consider that the light intensity I1 of the laser beam has reached its peak and may once end the set of processes in the flowchart. If the newly detected light intensity I1 of the laser beam is not equal to the past light intensity I1p (S507: NO), the laser control unit 700 may make the process go to S508.

In S508, the laser control unit 700 may determine whether or not the newly detected light intensity I1 of the laser beam exceeds the past light intensity I1p currently stored in the memory 1002 (I1p<I1).

After S508, the laser control unit 700 may determine whether or not the value of the second flag F1b is “1” (S509 or S510). A case in which the value of the second flag F1b is “0” will be explained later in the description of S512.

In the case where the light intensity I1 exceeds the past light intensity I1p (I1p<I1) and the value of the second flag F1b is “1” (S508: YES, S509: YES), the laser control unit 700 may make the process go to S511.

In the case where the light intensity I1 does not exceed the past light intensity I1p, in other words, the light intensity I1 is lowered and the value of the second flag F1b is “1” (S508: NO, S510: YES), the laser control unit 700 may make the process go to S512.

In S511, the laser control unit 700 may add the predetermined value ΔV to the voltage V currently stored in the memory 1002 and make a result of this addition be overwritten and stored in the memory 1002 as a new voltage V. The laser control unit 700 may send a voltage control signal to the drive power supply 50 so that the above new voltage V is applied to the piezoelectric element 44. In addition, the laser control unit 700 may set the value of the second flag F1b to “1” and make the memory 1002 overwrite and store this value of the flag.

In S512, the laser control unit 700 may subtract the predetermined value ΔV from the voltage V currently stored in the memory 1002 and make a result of this subtraction be overwritten and stored in the memory 1002 as a new voltage V. The laser control unit 700 may send a voltage control signal to the drive power supply 50 so that the above new voltage V is applied to the piezoelectric element 44. In addition, the laser control unit 700 may set the value of the second flag F1b to “0” and make the memory 1002 overwrite and store this value of the flag.

After S511 or S512, the laser control unit 700 may make the memory 1002 (to be explained later) overwrite and store the light intensity I1 having been received in S506 as the past light intensity I1p (S513). Thereafter, the laser control unit 700 may once end the set of processes in the flowchart.

When the set of processes in the flowchart is ended, the value of the first flag F1a can be set to “1” in S700 shown in FIG. 8. Thereafter, in the case where the selection wavelength control is not stopped in S900 (S900: NO) and the target selection wavelength is unchanged to be consecutively the first wavelength in S400, the process in S500 may be performed again. In the process of S500 that is performed again, because the value of the first flag F1a is set to “1”, the determination made at S501 in FIG. 9 may result in “NO”. Accordingly, S502 through S505 may be skipped, and then the process of S506 and the processes following S506 may be carried out. In this case, in the determination at S509 or S510, the value of the second flag F1b can be not only “1” but also can be “0”.

In the case where the light intensity I1 exceeds the past light intensity I1p (I1p<I1) and the value of the second flag F1b is “0” (S508: YES, S509: NO), the laser control unit 700 may make the process go to S512.

In the case where the light intensity I1 is lowered to be equal to or less than the past light intensity I1p and the value of the second flag F1b is “0” (S508: NO, S510: NO), the laser control unit 700 may make the process go to S511.

As described above, in the case where the light intensity I1 is raised (I1p<I1) because of adding the predetermined value ΔV to the voltage V (V=V+ΔV, F1b=1), the predetermined value ΔV can be further added to the voltage V (S511).

In the case where the light intensity I1 is lowered because of adding the predetermined value ΔV to the voltage V (V=V+ΔV, F1b=1), the predetermined value ΔV can be subtracted from the voltage V (S512).

In the case where the light intensity I1 is raised (I1p<I1) because of subtracting the predetermined value ΔV from the voltage V (V=V−ΔV, F1b=0), the predetermined value ΔV can be further subtracted from the voltage V (S512).

In the case where the light intensity I1 is lowered because of subtracting the predetermined value ΔV from the voltage V (V=V−ΔV, F1b=0), the predetermined value ΔV can be added to the voltage V (S511).

Through this, the voltage V can be controlled so that the light intensity I1 detected by the first light sensor 53 is intensified. As a result, the selection wavelength of the etalon En can be so controlled as to match the first wavelength. As described earlier, since the first wavelength is a wavelength included in the pulse laser beam 35 that is outputted by the master oscillator MO, the etalon En can be so controlled as to transmit the pulse laser beam 35 at high transmittance through the above controlling.

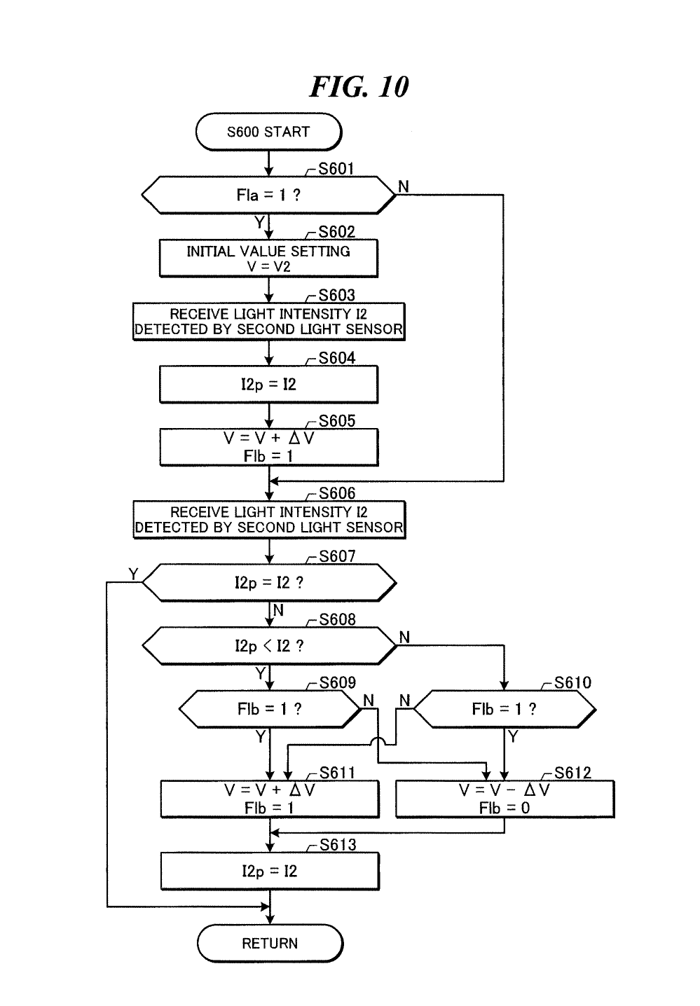

FIG. 10 is a flowchart illustrating another selection wavelength control shown in FIG. 8. A set of processes shown in FIG. 10 may be performed, by the laser control unit 700, as a subroutine of S600 shown in FIG. 8.

First, the laser control unit 700 may determine the value of the first flag F1a (S601). In the case where the processes of S400 through S900 in FIG. 8 have already been performed at least once and the target selection wavelength was the first wavelength in the previous processes of S400 through S900, the value of the first flag F1a can be “1” (S601: YES) because the process of S700 mentioned before was performed. In this case, because the target selection wavelength has been changed to the second wavelength in the current processes of S400 through S900, the laser control unit 700 may perform processes such as initial value setting (S602) and so on.

Meanwhile, in the case where the target selection wavelength was also the second wavelength in the previous processes of S400 through S900, the value of the first flag F1a can be “0” (S601: NO) because the process of S800 mentioned before was performed. In this case, because the target selection wavelength has not been changed yet, the laser control unit 700 may skip the processes such as the initial value setting (S602) and so on and make the process go to S606.

Note that, a case in which the laser control unit 700 performs, after S300 in FIG. 8, the processes of S400 through S900 for the first time will be described in detail later.

If the value of the first flag F1a is “1” (S601: YES), the laser control unit 700 may set the voltage V to an initial value V2 (S602). The laser control unit 700 may send a voltage control signal to the drive power supply 50 so that the above voltage V is applied to the piezoelectric element 44.

Next, the laser control unit 700 may receive data of light intensity I2 of a laser beam that has been detected by the second light sensor 54 (S603).

Subsequently, the laser control unit 700 may make the memory 1002 (to be explained later) store the light intensity I2 having been received in S603 as past light intensity I2p (S604).

Then, the laser control unit 700 may add the predetermined value ΔV to the voltage V and make a result of this addition be overwritten and stored in the memory 1002 as a new voltage V (S605). The laser control unit 700 may send a voltage control signal to the drive power supply 50 so that the above new voltage V is applied. to the piezoelectric element 44. In addition, the laser control unit 700 may set the value of the second flag F1b to “1” and make this value of the flag be stored in the memory 1002.

The subsequent processes (S606 through S613) shown in FIG. 10 are the same as those of S506 through S513 shown in FIG. 9 except that the first wavelength and the second wavelength are interchanged and variables used therein are changed so as to correspond to the second wavelength. Therefore, detailed description thereof will be omitted herein.

As described above, there can be a plurality of wavelengths other than the first wavelength that can be amplified by the amplifiers PA1, PA2, . . . , PAn such as the CO₂ laser amplifiers or the like. Accordingly, it can be difficult to attenuate all the plurality of wavelengths that can be amplified by the amplifiers PA1, PA2, . . . , PAn only by controlling the etalon En so that light of the first wavelength is not transmitted.

According to the set of processes shown in FIG. 10, the voltage V can be controlled so that the light intensity I2 detected by the second light sensor 54 is intensified. As a result, the selection wavelength of the etalon En can be so controlled as to match the second wavelength with pinpoint accuracy. Therefore, the etalon En can be so controlled as to attenuate any of the plurality of wavelengths that can be amplified by the amplifiers PA1, PA2, . . . , PAn.

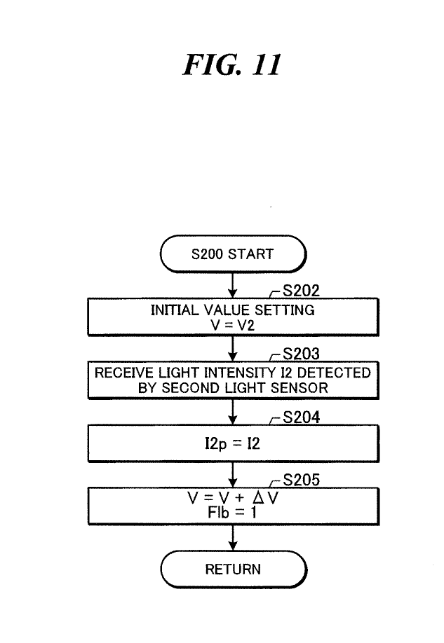

FIG. 11 is a flowchart illustrating the process of initial setting shown in FIG. 8. A set of processes shown in FIG. 11 may be performed by the laser control unit 700 as a subroutine of S200 shown in FIG. 8.

As specified in S202 through S205 in FIG. 11, the laser control unit 700 may perform the same processes as those of S602 through S605 in FIG. 10. The reason for this is as follows.

That is, after S300 in FIG. 8, in the case where the processes of S400 through 900 are performed for the first time and the target selection wavelength is determined to be the second wavelength in the process of S400, the first flag F1a can be determined to be “0” in S601 in FIG. 10. In this case, because the processes of S602 through S605 in FIG. 10 are skipped, the same processes as those of S602 through S605 are performed in advance in S200.

4.2 Etalon with Wide Control Range

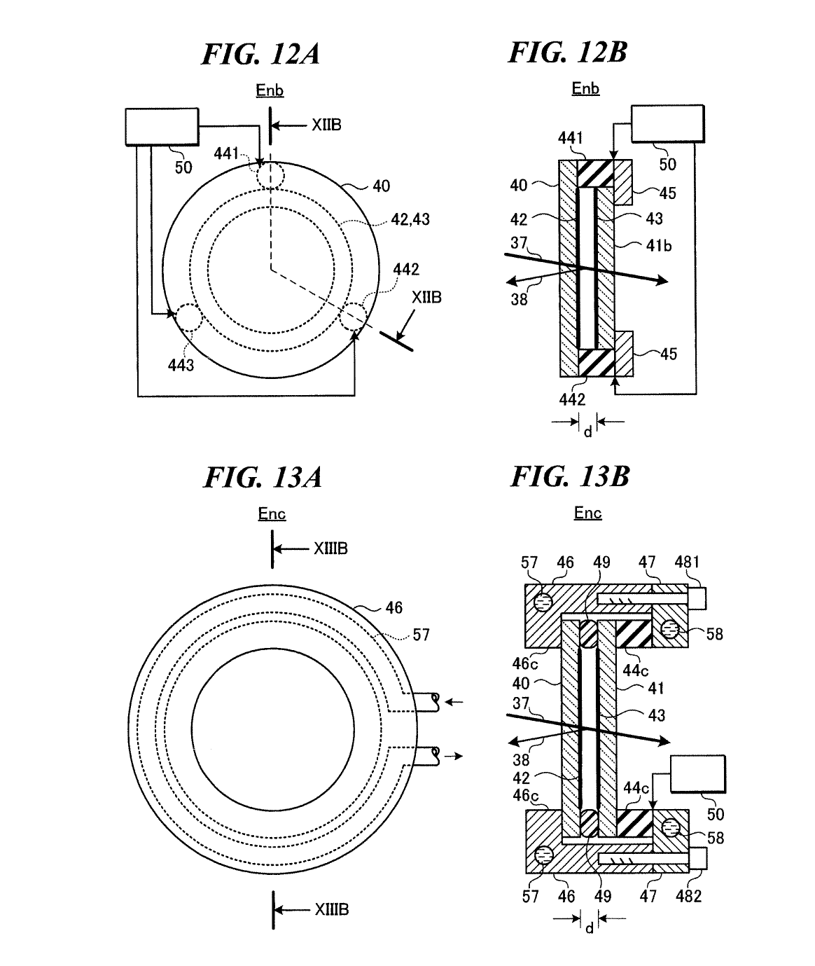

FIGS. 12A and 12B illustrate a configuration of a second variation on the wavelength selection element. More specifically, FIG. 12A is a plan view of an etalon Enb; FIG. 12B is a cross-sectional view of the etalon Enb taken along a line XIIB-XIIB in FIG. 12A. The configuration of the variation on the etalon En will be described hereinafter; however, the configurations of the etalons E0, E1, E2 and so on may be the same as the configuration of this variation.

The etalon Enb shown in FIGS. 12A and 12B may include a fixing member 45 in addition to the configuration of the etalon En having been discussed with reference to FIGS. 3A and 3B. The fixing member 45 may be configured of a ceramic such as aluminum nitride (AlN) which can be optically polished and has high thermal conductivity, or the like. Of the diamond substrate 40 and a diamond substrate 41b arranged in pairs, the diamond substrate 41b may be smaller in outer diameter.

The fixing member 45 may be shaped in a ring form. Size of the outer diameter of the fixing member 45 may be substantially the same as the size of the outer diameter of the diamond substrate 40, while size of the inner diameter of the fixing member 45 may be smaller than the size of the outer diameter of the diamond substrate 41b. One surface of the diamond substrate 41b may be coated with the partially reflective film 43, and the fixing member 45 may be attached to a circumferential edge portion of the other surface of the diamond substrate 41b.

On the circumference of the diamond substrate 41b, three piezoelectric elements 441, 442 and 443 may be fixed between the diamond substrate 40 and the fixing member 45. Although it is stated here that the etalon En includes the three piezoelectric elements 441, 442 and 443, the number of the piezoelectric elements may be an arbitrary number equal to or greater than one. The drive power supply 50 may be connected to each of the piezoelectric elements 441, 442 and 443.

According to the second variation described above, it is possible for thicknesses of the piezoelectric elements 441, 442 and 443 to be larger than the distance “d” between the partially reflective films 42 and 43 by the thickness of the diamond substrate 41b. Accordingly, an amount of displacement of the piezoelectric elements 441, 442 and 443 can be made larger. As a result, it is possible to enlarge a control range of the distance “d” between the partially reflective films 42 and 43.

### 4.3 Etalon Capable of Being Cooled

FIGS. 13A and 13B illustrate a configuration of a third variation on the wavelength selection element. More specifically, FIG. 13A is a plan view of an etalon Enc, and FIG. 13B is a cross-sectional view of the etalon Enc taken along a line XIIIB-XIIIB in FIG. 13A. The configuration of the variation on the etalon En will be described hereinafter; however, the configurations of the etalons E0, E1, E2 and so on may be the same as the configuration of this variation.

The etalon Enc shown in FIGS. 13A and 13B may include a cylinder holder 46 and a ring member 47 in addition to the configuration of the etalon En having been discussed with reference to FIGS. 3A and 3B. At one end of the cylinder holder 46, there may be formed a flange portion 46c protruding inward. The ring member 47 may be fixed to the other end of the cylinder holder 46. The outer diameter dimension of the ring member 47 may be substantially the same as the outer diameter dimension of the cylinder holder 46. The inner diameter dimension of the ring member 47 may be substantially the same as the inner diameter dimension of the flange portion 46c of the cylinder holder 46, and may be smaller than the outside dimension of the diamond substrates 40 and 41. Inside the cylinder holder 46 and ring member 47, there may be respectively formed a coolant flow path 57 and a coolant flow path 58.

The diamond substrates 40, 41 and a ring-formed piezoelectric element 44c may be held in a space surrounded by the cylinder holder 46 and the ring member 47. One surface of the diamond substrate 40 may be coated with the partially reflective film 42, while the circumferential edge portion of the other surface of the diamond substrate 40 may be attached to the flange portion 46c of the cylinder holder 46. One surface of the diamond substrate 41 may be coated with the partially reflective film 43, while the piezoelectric element 44c may be fixed between the circumferential edge portion of the other surface of the diamond substrate 41 and the ring member 47. A ring-formed elastic member 49 may be sandwiched between the diamond substrates 40 and 41. The cylinder holder 46 and the ring member 47 may be fixed to each other with bolts 481 and 482.

The piezoelectric element 44c may deform due to a voltage applied thereto by the drive power supply 50 so that the elastic member 49 may deform so as to change the distance “d” between the partially reflective films 42 and 43. A coolant pump (not shown) and a heat exchanger (not shown) may be connected to the coolant flow path 57 and the coolant flow path 58 so that a coolant such as water may be circulated. The elastic member 49 may be omitted.

According to the third variation discussed above, even if the etalon Enc is heated by the pulse laser beam 35 entering the etalon Enc in a repeating manner, the heat generated in the etalon Enc can be released through the coolant flowing in the coolant flow path 57 and the coolant flow path 58. This makes it possible to suppress the distance “d” between the partially reflective films 42 and 43 from being changed due to heat expansion of the etalon Enc, and control the selection wavelength of the etalon Enc with high precision.

Further, according to the third variation, a thickness of the piezoelectric element 44c can be designed without being constrained by the distance “d” between the partially reflective films 42 and 43, the thickness of the diamond substrates 40 and 41, and the like. Accordingly, it is possible to make the thickness of the piezoelectric element 44c larger so as to make the amount of displacement of the piezoelectric element 44c larger, and consequently enlarge the control range of the distance “d” between the partially reflective films 42 and 43.

### 4.4 Combination of Grating and Slit

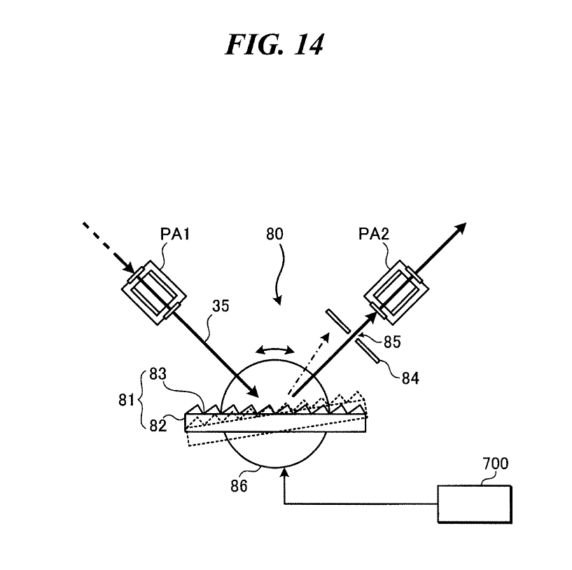

FIG. 14 schematically illustrates a configuration of a fourth variation on the wavelength selection element. The wavelength selection elements in the present disclosure are not limited to the etalons E0, E1, E2, . . . , En (See FIG. 2). A combination of a grating 81 and a plate 84 in which a slit 85 is formed may be used as a wavelength selection element 80.

The grating 81 may include a substrate 82 and a plurality of grooves 83 formed on one surface of the substrate 82. In the plurality of grooves 83, light of a wavelength band which is in the vicinity of the first wavelength may be reflected at high reflectance. The grating 81 may be fixed to a rotation drive mechanism 86. The rotation drive mechanism 86 may be capable of changing an installation angle of the grating 81 according to a drive signal outputted by the laser control unit 700. A rotational shaft of the grating 81 rotated by the rotation drive mechanism 86 may be approximately parallel to a direction of the plurality of grooves 83. The plate 84 may be disposed so that a lengthwise direction of the slit 85 is approximately parallel to the direction of the plurality of grooves 83 of the grating 81.

The grating 81 may be disposed in the light path of the laser beam 35 outputted from the master oscillator MO (see FIG. 2). Although an example in which the grating 81 is disposed on a downstream side of the amplifier PA1 is illustrated in FIG. 14, the present disclosure is not limited thereto. Note that the “downstream side” can be the side of a direction that extends toward the plasma generation region 25 along the light paths of the pulse laser beams 35, 31, 32 and 33 originally outputted from the master oscillator MO.

The pulse laser beam 35 may be incident on a surface of the grating 81 where the plurality of grooves 83 are formed. The pulse laser beam 35 incident on the grating 81 can be reflected at slopes of the plurality of grooves 83 in multiple directions perpendicular to the direction of the plurality of grooves 83. When a beam of reflection light reflected at the slope of one groove and a beam of reflection light reflected at the surface of another groove are superposed each other, a difference in length between the light paths of the two beams of reflection light can depend on the reflection angle of the beams of reflection light. Beams of light of a wavelength that corresponds to the difference in length between the light paths match each other in phase and can intensify each other; whereas beams of light of a wavelength that does not correspond to the difference in length between the light paths do not match each other in phase and can weaken each other. As a result of this interferential action, in accordance with the reflection angle, light of a specified wavelength can be intensified and can pass through the slit 85.

By the rotation drive mechanism 86 changing the installation angle of the grating 81 as indicated with broken lines, it is possible to change a difference in length of light paths of the beams of reflection light that are reflected at the slopes of the plurality of grooves 83 and reach the slit 85. Through this, the selection wavelength of the wavelength selection element can be controlled to be the first wavelength and the second wavelength.

The case in which the grating 81 is used is described in the fourth variation; however, a dispersing prism may be used instead.

### 5. Variation on Laser Control Unit

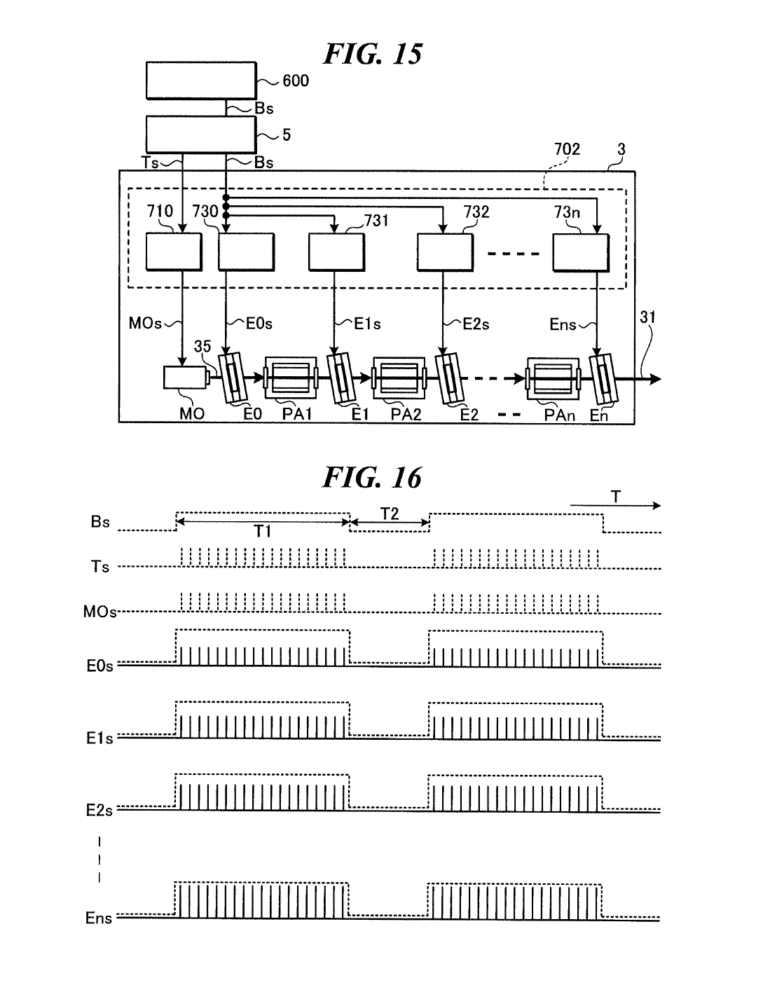

FIG. 15 illustrates a configuration of the laser apparatus including a variation on the laser control unit. A laser control unit 702 according to the variation may not include the delay circuit. The laser control unit 702 may include the one-shot circuit 710 and a plurality of buffer circuits 730, 731, 732, . . . , 73n.

The one-shot circuit 710 may be connected with the EUV light generation controller 5 via a signal line. The one-shot circuit 710 may be connected with the master oscillator MO via a signal line. The plurality of buffer circuits 730, 731, 732, . . . , 73n may be connected with the EUV light generation controller 5 via signal lines. The plurality of buffer circuits 730, 731, 732, . . . , 73n may be respectively connected with the drive power supplies 50 of the etalons E0, E1, E2, . . . , En. Note that each drive power supply 50 illustrated in FIG. 3B is omitted in FIG. 15.

The EUV light generation controller 5 may receive a burst signal Bs from an exposure apparatus controller 600 included in the exposure apparatus 6 (see FIG. 1). The EUV light generation controller 5 may generate a trigger signal Ts based on the burst signal Bs and output the generated trigger signal Ts to the one-shot circuit 710. Further, the EUV light generation controller 5 may output the burst signal Bs as-is to the plurality of buffer circuits 730, 731, 732, . . . , 73n.

The one-shot circuit 710 may output the drive signal MOs based on the trigger signal Ts to the master oscillator MO. The plurality of buffer circuits 730, 731, 732, . . . , 73n may output the plurality of drive signals E0s, E1s, E2s, . . . , Ens based on the burst signal Bs to the respective drive power supplies 50 (see FIG. 3B) of the etalons E0, E1, E2, . . . , En.

FIG. 16 is a timing chart of the laser apparatus shown in FIG. 15. In FIG. 16, the horizontal direction represents the passage of time T, while broken lines represent the burst signal Bs, the trigger signal Ts, and the drive signals MOs, E0s, E1s, E2s, . . . , Ens. The timing chart in FIG. 16 is illustrated with a larger time scale than that in FIG. 6.

The EUV light generation controller 5 may receive the burst signal Bs from the exposure apparatus controller 600. The burst signal Bs may be a signal that is ON during a first period T1 and OFF during a second period T2 which begins right after the end of the first period T1. The first period T1 may be such a period that is specified by the exposure apparatus controller 600 as a period during which the master oscillator MO repeatedly outputs the pulse laser beams 35. The second period T2 may be such a period that is specified by the exposure apparatus controller 600 as a period during which the master oscillator MO stops the repeated output of the pulse laser beams 35.

The EUV light generation controller 5 may repeatedly output the trigger signals Ts during the first period T1 during which the burst signal is ON. The EUV light generation controller 5 may stop the output of the trigger signal Ts during the second period T2 during which the burst signal Es is OFF. A burst operation may be carried out in which the one-shot circuit 710 repeatedly outputs the drive signal MOs in response to the trigger signal Ts and the master oscillator MO repeatedly outputs the pulse laser beam 35 in response to the drive signal MOs.

The buffer circuit 730 may output the drive signal E0s to the etalon E0 in synchronization with the burst signal Bs. The drive signal E0s may be ON during the first period T1 during which the burst signal Bs is ON so that the etalon E0 may be in the first state in which light of the first wavelength is transmitted. This may allow the pulse laser beam 35 to pass through the etalon E0. The waveform of the pulse laser beam 35 is schematically illustrated with a solid line in FIG. 16. During the second period T2 during which the burst signal Bs is OFF, the drive signal E0s may be OFF so that the etalon E0 may be in the second state in which light of the second wavelength is transmitted. This may cause the spontaneous emission light from the amplifier to be attenuated in the etalon E0.

Likewise, the buffer circuits 731, 732, . . . , 73n may respectively output the drive signals E1s, E2s, Ens to the etalons E1, E2, . . . , En, in synchronization with the burst signal Bs.

According to this variation, during the second period T2 during which the burst signal Bs is OFF, it is possible to suppress the spontaneous emission light outputted by the amplifier from entering the master oscillator MO, striking the target 27, and so on. This control can be realized even in the case where operational speeds of the plurality of etalons E0, E1, E2, . . . , En are slower in comparison with the case of the control having been discussed with reference to FIGS. 5 and 6.

### 6. Other Variations

In the above descriptions, the example in which the respective wavelength selection elements are disposed on the downstream side of the master oscillator MO and also on the downstream side of the plurality of amplifiers PA1 through PAn is given; however, the present disclosure is not limited thereto. It may be sufficient that at least one wavelength selection element is disposed at a position anywhere in the light path of the pulse laser beam 35 between the master oscillator MO and the plasma generation region 25.

In the description of FIGS. 5 and 6, the example in which the selection wavelength of the wavelength selection element is switched in synchronization with respective pulses included in the pulse laser beam 35 is given. Meanwhile, in the description of FIGS. 15 and 16, the example in which the selection wavelength of the wavelength selection element is switched in synchronization with the burst signal Bs is given. However, the present disclosure is not limited thereto. Any one of the plurality of wavelength selection elements disposed in the light path of the pulse laser beam 35 may synchronize with the respective pulses included in the pulse laser beam 35 while another one of the plurality of wavelength selection elements may synchronize with the burst signal Bs, in order to make the selection wavelength be switched.

Further, any one of the plurality of wavelength selection elements discussed above may be replaced with an optical shutter. The optical shutter may be an optical element that is capable of controlling the pulse laser beam 35, under the control of the laser control unit 700 or the laser control unit 702, so that the pulse laser beam 35 is transmitted or not transmitted. For example, the optical shutters may be disposed between the master oscillator MO and the amplifier PA1, between the amplifiers PA1 and the amplifier PA2, and so on, while the etalon En may be disposed on the downstream side of the last-stage amplifier PAn. Since the etalon is, in general, highly resistant to the pulse laser beam 35 having large energy, the etalon can sufficiently exhibit its excellent performance also at the position on the downstream side of the last-stage amplifier PAn.

### 7. Configuration of Controller

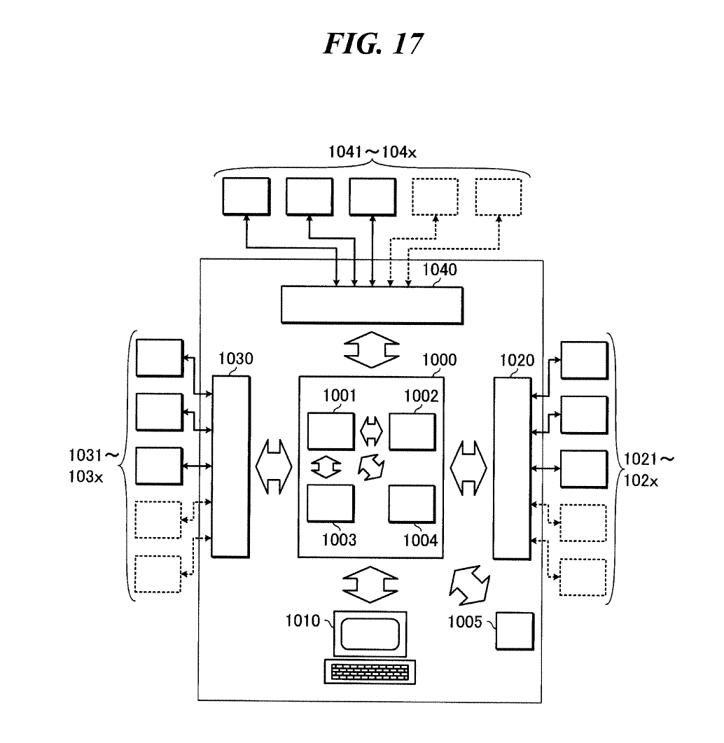

FIG. 17 is a block diagram illustrating a general configuration of a controller.

Controllers such as the laser control unit 700, the laser control unit 702, and the like in the above-described embodiments may be configured of general control devices such as a computer, a programmable controller, and the like. For example, the stated controller may be configured as follows.

### Configuration

The controller may be configured of a processing unit 1000, a storage memory 1005 connected with the processing unit 1000, a user interface 1010, a parallel I/O controller 1020, a serial I/O controller 1030, and an A/D-D/A converter 1040. Further, the processing unit 1000 may be configured of a CPU 1001, the memory 1002 connected with the CPU 1001, a timer 1003, and a GPU 1004.

### Operation

The processing unit 1000 may read out a program stored in the storage memory 1005. The processing unit 1000 may execute the program that has been read out, and according to the execution of the program, may read out data from the storage memory 1005, make the storage memory 1005 store the data, and so on.

The parallel I/O controller 1020 may be connected with devices 1021 through 102x communicable via parallel I/O ports. The parallel I/O controller 1020 may control communications in digital performed by the processing unit 1000 via the parallel I/O ports during the execution of the program.

The serial I/O controller 1030 may be connected with devices 1031 through 103x communicable via serial I/O ports. The serial I/O controller 1030 may control communications in digital performed by the processing unit 1000 via the serial I/O ports during the execution of the program.

The A/D-D/A converter 1040 may be connected with devices 1041 through 104x communicable via analog ports. The A/D-D/A converter 1040 may control communications in analog performed by the processing unit 1000 via the analog ports during the execution of the program.

The user interface 1010 may be configured so that an operator displays the process of execution of the program performed by the processing unit 1000, makes the processing unit 1000 stop the execution of the program or perform interrupt processing, and so on.

The CPU 1001 in the processing unit 1000 may perform arithmetic processing of the program. The memory 1002 may temporarily store the program during the CPU 1001 executing the program, temporarily store data during the process of performing the arithmetic processing, and so on. The timer 1003 may measure clock time, elapsed time, and the like, and may output the clock time, the elapsed time, and the like into the CPU 1001 according to the execution of the program. The CPU 1004 may process image data according to the execution of the program when the image data is inputted into the processing unit 1000, and output a result of the processing to the CPU 1001.

The devices 1021 through 102x connected with the parallel I/O controller 1020 and communicable via the parallel I/O ports, may be the EUV light generation controller 5, other controllers and so on.

The devices 1031 through 103x connected with the serial I/O controller 1030 and communicable via the serial I/O ports, may be the master oscillator MO, the drive power supply 50 of the etalon, the first light source 51, the second light source 52, and so on.

The devices 1041 through 104x connected with the A/D-D/A converter 1040 and communicable via the analog ports, may be various types of sensors such as the first light sensor 53, the second light sensor 54, and the like.

The controller, with the configuration described above, may be capable of implementing the operations illustrated in the flowcharts.

The above-described embodiments and the modifications thereof are merely examples for implementing the present disclosure, and the present disclosure is not limited thereto. Making various modifications according to the specifications or the like is within the scope of the present disclosure, and other various embodiments are possible within the scope of the present disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A laser apparatus comprising:
a master oscillator configured to output a pulse laser beam;
an amplifier disposed in a light path of the pulse laser beam;
a wavelength selection element disposed in the light path of the pulse laser beam and configured to transmit light of a selection wavelength at higher transmittance than transmittance of light of other wavelengths; and
a controller configured to change the selection wavelength of the wavelength selection element.

2. The laser apparatus according to claim 1,
wherein the wavelength selection element is configured to be switched by the controller between a first state in which a first wavelength is the selection wavelength while a second wavelength is not the selection wavelength and a second state in which the second wavelength is the selection wavelength while the first wavelength is not the selection wavelength,
the master oscillator is configured to output the pulse laser beam including light of the first wavelength, and
the amplifier is configured to amplify light of the first wavelength at a larger amplification factor than an amplification factor of light of the second wavelength.

3. The laser apparatus according to claim 1,
wherein the wavelength selection element is disposed in the light path of the pulse laser beam at a position on a downstream side of the amplifier in the light path of the pulse laser beam.

4. The laser apparatus according to claim 1,
wherein the wavelength selection element includes an etalon that is provided with a first substrate on one surface of which a first partially reflective film is formed, a second substrate which is disposed opposing the first substrate and on a surface of which a second partially reflective film is formed while the surface opposing the first partially reflective film, and a piezoelectric element configured to increase/decrease a distance between the first substrate and the second substrate.

5. The laser apparatus according to claim 2,
wherein the amplifier is configured to amplify light of a third wavelength different from the first wavelength at a larger amplification factor than the amplification factor of light of the second wavelength, and
the wavelength selection element includes the third wavelength within a free spectral range in the first state and also within a free spectral range in the second state.

6. The laser apparatus according to claim 1,
wherein the master oscillator is configured to output the pulse laser beam including multiple pulses, and
the controller is configured to change the selection wavelength of the wavelength selection element in synchronization with each of the multiple pulses.

7. The laser apparatus according to claim 2,
wherein the master oscillator is configured to output the pulse laser beam including multiple pulses, and
the controller is configured to change the selection wavelength of the wavelength selection element so that the wavelength selection element is in the first state in a first period during which the master oscillator repeatedly outputs the multiple pulses whereas the wavelength selection element is in the second state in a second period during which the master oscillator stops the repeated output of the multiple pulses.

8. The laser apparatus according to claim 2, further comprising:
a light source configured to emit light of the second wavelength toward the wavelength selection element; and
a light sensor disposed in a light path of the light that is emitted from the light source and passes through the wavelength selection element,
wherein the controller is configured to change the selection wavelength of the wavelength selection element in accordance with output of the light sensor.

9. An extreme ultraviolet light generation apparatus comprising:
a laser apparatus that includes a master oscillator configured to output a pulse laser beam, an amplifier disposed in a light path of the pulse laser beam, a wavelength selection element disposed in the light path of the pulse laser beam and configured to transmit light of a selection wavelength at higher transmittance than transmittance of light of other wavelengths, and a controller configured to change the selection wavelength of the wavelength selection element;
a chamber provided with an incidence opening through which a pulse laser beam outputted from the laser apparatus passes into the inside of the chamber;
a target supply device configured to output a target into the chamber; and
a laser beam focusing optical system configured to focus the pulse laser beam inside the chamber.
